(19) United States
(12) Patent Application Publication
(10) Pub. No.: US 2021/0231473 A1
(43) Pub. Date: Jul. 29, 2021

(54) DIFFERENTIAL PRESSURE TYPE FLOWMETER

(71) Applicant: Azbil Corporation, Tokyo (JP)

(72) Inventors: Kouji YUUKI, Tokyo (JP); Hirofumi TOJO, Tokyo (JP); Nozomi KIDA, Tokyo (JP)

(73) Assignee: Azbil Corporation, Tokyo (JP)

(21) Appl. No.: 17/151,235

(22) Filed: Jan. 18, 2021

(30) Foreign Application Priority Data
Jan. 24, 2020 (JP) 2020-009872

(51) Int. Cl. G01F 1/38; G01F 1/46; G01F 1/36

(52) U.S. Cl. CPC G01F 1/383; G01F 1/363; G01F 1/46

(57) ABSTRACT

A flow rate measurement error is reduced by a differential pressure type flowmeter that includes: a pipe; a laminar flow element disposed within the pipe; a first absolute pressure sensor measuring an absolute pressure P1 of a fluid upstream of the laminar flow element; a second absolute pressure sensor measuring an absolute pressure P2 of the fluid downstream; a temperature sensor measuring an ambient temperature T of the absolute pressure sensors; a pressure calculation section correcting an output signal from the first absolute pressure sensor based on the temperature T to be converted into the absolute pressure P1, and correcting an output signal from the second absolute pressure sensor based on the temperature T to be converted into the absolute pressure P2; and a flow rate calculation section calculating a flow rate of the fluid based on the absolute pressures P1 and P2 calculated by the pressure calculation section.

### CROSS REFERENCE TO RELATED APPLICATIONS

This patent application claims the benefit of foreign priority to Japanese Patent Application No. JP 2020-009872 filed on Jan. 24, 2020, the disclosure of which is hereby incorporated by reference in its entirety.

### BACKGROUND OF THE INVENTION

The present disclosure relates to a differential pressure type flowmeter such as a laminar flow type flowmeter.

A laminar flow type flowmeter is a flowmeter that uses a phenomenon in which a pressure drop accompanying a movement of a fluid is proportional to a volumetric flow rate in a case in which the fluid flows in a pipe in a laminar flow state (PTL 1 and PTL 2). A relationship between the fluid passing through a laminar flow element and a generated differential pressure ΔP is normally expressed by the following Equation.

Qm=ΔP×π×d⁴×ρ/(128×μ×L) (1)

In Equation (1), Qm denotes a mass flow rate, d denotes a flow path diameter of the laminar flow element, L denotes a flow path length of the laminar flow element, μ denotes a viscosity coefficient, and ρ is a density of the fluid.

As illustrated in FIG. 15, the laminar flow type flowmeter has absolute pressure sensors 101 and 102 disposed upstream and downstream of a laminar flow element 100, respectively, and the laminar flow type flowmeter calculates the differential pressure ΔP generated when the fluid passes through the laminar flow element 100 by a difference (P1−P2) between an absolute pressure P1 measured by the absolute pressure sensor 101 and an absolute pressure P2 measured by the absolute pressure sensor 102.

In the laminar flow type flowmeter illustrated in FIG. 15, outputs from the absolute pressure sensors vary depending on an influence of an ambient temperature; thus, a pressure measurement error occurs due to a difference in ambient temperature between the two absolute pressure sensors 101 and 102, with the result that a problem occurs in which it is impossible to accurately measure the differential pressure within the laminar flow element 100.

As other configurations, temperature sensors 103 and 104 are provided near the absolute pressure sensors 101 and 102 as illustrated in FIG. 16, and a method of correcting the outputs from the absolute pressure sensors 101 and 102 by temperatures T1 and T2 measured by the temperature sensors 103 and 104 is adopted.

FIG. 17 is a plan view of the absolute pressure sensor 101 and FIG. 18 is a cross-sectional view taken along line A-A of FIG. 17. The absolute pressure sensor 101 is configured from a planar sensor chip 110. The sensor chip 110 is configured from a planar pressure guidance pedestal 111 formed from glass, a planar pressure-sensitive member 112 bonded with the pressure guidance pedestal 111 and formed from silicon, and a planar lid member 113 bonded with the pressure-sensitive member 112 and formed from silicon.

A through-hole 114 that serves as a pressure guidance path penetrating the pressure guidance pedestal 111 from a rear surface to a front surface is formed in the pressure guidance pedestal 111.

A recess portion 115 (pressure guidance chamber) formed by removing a rear surface side of the pressure-sensitive member 112 so that a front surface side thereof remains is formed in a rear surface of the pressure-sensitive member 112 facing the pressure guidance pedestal 111. A part remaining on the front surface side of a region where the recess portion 115 of the pressure-sensitive member 112 is formed serves as a diaphragm 116.

A recess portion 117 (pressure reference chamber) formed by removing a rear surface side of the lid member 113 so that a front surface side thereof remains is formed in a rear surface of the lid member 113 facing the pressure-sensitive member 112 at a position at which the diaphragm 116 is covered with the recess portion 117 when the pressure-sensitive member 112 and the lid member 113 are bonded with each other.

The pressure guidance pedestal 111 and the pressure-sensitive member 112 are bonded with each other so that the through-hole 114 of the pressure guidance pedestal 111 is in communication with the recess portion 115 of the pressure-sensitive member 112.

The pressure-sensitive member 112 and the lid member 113 are bonded with each other so that the diaphragm 116 of the pressure-sensitive member 112 is covered with the recess portion 117 of the lid member 113.

The recess portion 117 is sealed in a vacuum state. Examples of a scheme for converting a deformation of the diaphragm 116 into a pressure value include a semiconductor piezoresistance scheme and a capacitance scheme.

Thus, forming the diaphragm 116 for pressure detection and the temperature sensor 103 formed from a metallic thin film heat-sensitive resistive element on the sensor chip 110 makes it possible to measure the absolute pressure P1 applied to a lower surface of the diaphragm 116 and, at the same time, to measure a temperature of the sensor chip 110. Configurations of the absolute pressure sensor 102 and the temperature sensor 104 are the same as those of the absolute pressure sensor 101 and the temperature sensor 103.

With the configurations illustrated in FIGS. 16 to 18, however, the pressures measured upstream and downstream of the laminar flow element 100 are affected by temperature measurement errors of the temperature sensors 103 and 104; thus, a differential pressure measurement error grows, with the result that a flow rate measurement error possibly grows.

The problems described so far occur not only in the laminar flow type flowmeter but also similarly in a differential pressure type flowmeter using an orifice plate, a pitot tube, or the like as a differential pressure generation mechanism.

### CITATION LIST

### Patent Literature

[PTL 1] Japanese Patent No. 4987977

[PTL 2] JP-A-2015-34762

### BRIEF SUMMARY OF THE INVENTION

The present disclosure has been achieved to solve the problems, and an object of the present disclosure is to provide a differential pressure type flowmeter capable of reducing a flow rate measurement error.

A differential pressure type flowmeter according to the present disclosure includes: a pipe circulating a fluid to be measured; a differential pressure generation mechanism that is installed within the pipe and that generates a differential pressure between the fluid on an upstream side and the fluid on a downstream side; a first absolute pressure sensor configured to measure a first absolute pressure of the fluid upstream of the differential pressure generation mechanism; a second absolute pressure sensor configured to measure a second absolute pressure of the fluid downstream of the differential pressure generation mechanism; a temperature sensor configured to measure an ambient temperature of the first and second absolute pressure sensors; a pressure calculation section configured to correct an output signal from the first absolute pressure sensor on the basis of the temperature measured by the temperature sensor to be converted into the first absolute pressure, and configured to correct an output signal from the second absolute pressure sensor on the basis of the temperature measured by the temperature sensor to be converted into the second absolute pressure; and a flow rate calculation section configured to calculate a flow rate of the fluid on the basis of the first and second absolute pressures calculated by the pressure calculation section, and is characterized in that a diaphragm of the first absolute pressure sensor for receiving the first absolute pressure, a diaphragm of the second absolute pressure sensor for receiving the second absolute pressure, and the temperature sensor are integrated in one sensor chip.

Furthermore, a first configuration example of the differential pressure type flowmeter according to the present disclosure is characterized in that the diaphragm of the first absolute pressure sensor for receiving the first absolute pressure, the diaphragm of the second absolute pressure sensor for receiving the second absolute pressure, the temperature sensor, a first pressure guidance path that transmits the first absolute pressure to the diaphragm of the first absolute pressure sensor, and a second pressure guidance path that transmits the second absolute pressure to the diaphragm of the second absolute pressure sensor are provided within the sensor chip.

Moreover, a differential pressure type flowmeter according to the present disclosure includes: a pipe circulating a fluid to be measured; a differential pressure generation mechanism that is installed within the pipe and that generates a differential pressure between the fluid on an upstream side and the fluid on a downstream side; a differential pressure sensor configured to measure a differential pressure between a first absolute pressure of the fluid upstream of the differential pressure generation mechanism and a second absolute pressure of the fluid downstream of the differential pressure generation mechanism; an absolute pressure sensor configured to measure the second absolute pressure; a temperature sensor configured to measure an ambient temperature of the differential pressure sensor and the absolute pressure sensor; a pressure calculation section configured to correct an output signal from the differential pressure sensor on the basis of the temperature measured by the temperature sensor to be converted into the differential pressure, and configured to correct an output signal from the absolute pressure sensor on the basis of the temperature measured by the temperature sensor to be converted into the second absolute pressure; and a flow rate calculation section configured to calculate a flow rate of the fluid on the basis of the differential pressure and the second absolute pressure calculated by the pressure calculation section, and is characterized in that a diaphragm of the first absolute pressure sensor for receiving the first absolute pressure, a diaphragm of the second absolute pressure sensor for receiving the second absolute pressure, and the temperature sensor are integrated in one sensor chip.

Furthermore, a first configuration example of the differential pressure type flowmeter according to the present disclosure is characterized in that the diaphragm of the differential pressure sensor for receiving the first absolute pressure, the diaphragm of the absolute pressure sensor for receiving the second absolute pressure, the temperature sensor, a first pressure guidance path that transmits the first absolute pressure to a first surface of the diaphragm of the differential pressure sensor, a second pressure guidance path that transmits the second absolute pressure to a second surface opposite to the first surface of the diaphragm of the differential pressure sensor, and a third pressure guidance path that transmits the second absolute pressure to the diaphragm of the absolute pressure sensor are provided within the sensor chip.

Moreover, a differential pressure type flowmeter according to the present disclosure includes: a pipe circulating a fluid to be measured; a differential pressure generation mechanism that is installed within the pipe and that generates a differential pressure between the fluid on an upstream side and the fluid on a downstream side; a first absolute pressure sensor configured to measure a first absolute pressure of the fluid upstream of the differential pressure generation mechanism; a second absolute pressure sensor configured to measure a second absolute pressure of the fluid downstream of the differential pressure generation mechanism; a temperature sensor configured to measure an ambient temperature of the first and second absolute pressure sensors; a pressure calculation section configured to correct an output signal from the first absolute pressure sensor on the basis of the temperature measured by the temperature sensor to be converted into the first absolute pressure, and configured to correct an output signal from the second absolute pressure sensor on the basis of the temperature measured by the temperature sensor to be converted into the second absolute pressure; and a flow rate calculation section configured to calculate a flow rate of the fluid on the basis of the first and second absolute pressures calculated by the pressure calculation section, and is characterized in that a sensor chip of the first absolute pressure sensor, a sensor chip of the second absolute pressure sensor, and the temperature sensor are accommodated in one package.

Furthermore, a first configuration example of the differential pressure type flowmeter according to the present disclosure is characterized in that a diaphragm of the first absolute pressure sensor for receiving the first absolute pressure, and a first pressure guidance path that transmits the first absolute pressure to the diaphragm of the first absolute pressure sensor are provided within the sensor chip of the first absolute pressure sensor, and in that a diaphragm of the second absolute pressure sensor for receiving the second absolute pressure, and a second pressure guidance path that transmits the second absolute pressure to the diaphragm of the second absolute pressure sensor are provided within the sensor chip of the second absolute pressure sensor.

Furthermore, a differential pressure type flowmeter according to the present disclosure includes: a pipe circulating a fluid to be measured; a differential pressure generation mechanism that is installed within the pipe and that generates a differential pressure between the fluid on an upstream side and the fluid on a downstream side; a differential pressure sensor configured to measure a differential pressure between a first absolute pressure of the fluid upstream of the differential pressure generation mechanism and a second absolute pressure of the fluid downstream of the differential pressure generation mechanism; an absolute pressure sensor configured to measure the second absolute pressure; a temperature sensor configured to measure an ambient temperature of the differential pressure sensor and the absolute pressure sensor; a pressure calculation section configured to correct an output signal from the differential pressure sensor on the basis of the temperature measured by the temperature sensor to be converted into the differential pressure, and configured to correct an output signal from the absolute pressure sensor on the basis of the temperature measured by the temperature sensor to be converted into the second absolute pressure; and a flow rate calculation section configured to calculate a flow rate of the fluid on the basis of the differential pressure and the second absolute pressure calculated by the pressure calculation section, and is characterized in that a sensor chip of the differential pressure sensor, a sensor chip of the absolute pressure sensor, and the temperature sensor are accommodated in one package.

Furthermore, a first configuration example of the differential pressure type flowmeter according to the present disclosure is characterized in that a diaphragm of the differential pressure sensor for receiving the first absolute pressure and the second absolute pressure, a first pressure guidance path that transmits the first absolute pressure to a first surface of the diaphragm of the differential pressure sensor, a second pressure guidance path that transmits the second absolute pressure to a second surface opposite to the first surface of the diaphragm of the differential pressure sensor are provided within the sensor chip of the differential pressure sensor, and a diaphragm of the absolute pressure sensor for receiving the second absolute pressure, and a third pressure guidance path that transmits the second absolute pressure to the diaphragm of the absolute pressure sensor are provided within the sensor chip of the absolute pressure sensor.

According to the present disclosure, it is possible to reduce pressure measurement errors due to an influence of the temperature and reduce flow rate measurement errors by integrating the diaphragm of the first absolute pressure sensor, the diaphragm of the second absolute pressure sensor, and the temperature sensor in one sensor chip.

Furthermore, according to the present disclosure, it is possible to reduce pressure measurement errors due to the influence of the temperature and reduce flow rate measurement errors by integrating the diaphragm of the differential pressure sensor, the diaphragm of the absolute pressure sensor, and the temperature sensor in one sensor chip.

Moreover, according to the present disclosure, it is possible to reduce pressure measurement errors due to the influence of the temperature and reduce flow rate measurement errors by accommodating the sensor chip of the first absolute pressure sensor, the sensor chip of the second absolute pressure sensor, and the temperature sensor in one package.

Furthermore, according to the present disclosure, it is possible to reduce pressure measurement errors due to the influence of the temperature and reduce flow rate measurement errors by accommodating the sensor chip of the differential pressure sensor, the sensor chip of the absolute pressure sensor, and the temperature sensor in one package.

### BRIEF DESCRIPTION OF THE SEVERAL VIEWS OF THE DRAWING

FIG. 1 is a diagram illustrating configurations of a laminar flow type flowmeter according to a first embodiment of the present disclosure.

FIG. 2 is a plan view of a sensor chip mounting thereon absolute pressure sensors and a temperature sensor of the laminar flow type flowmeter according to the first embodiment of the present disclosure.

FIG. 3 is a cross-sectional view of the sensor chip mounting thereon the absolute pressure sensors and the temperature sensor of the laminar flow type flowmeter according to the first embodiment of the present disclosure.

FIG. 4 is a cross-sectional view illustrating a state of mounting the sensor chip of the laminar type flowmeter on a diaphragm base according to the first embodiment of the present disclosure.

FIG. 5 is a circuit diagram of a Wheatstone bridge circuit in the absolute pressure sensor according to the first embodiment of the present disclosure.

FIG. 6 is a diagram illustrating configurations of a laminar flow type flowmeter according to a second embodiment of the present disclosure.

FIG. 7 is a plan view of a sensor chip mounting thereon absolute pressure sensors and a temperature sensor of the laminar flow type flowmeter according to the second embodiment of the present disclosure.

FIG. 8 is a cross-sectional view of the sensor chip mounting thereon the absolute pressure sensors and the temperature sensor of the laminar flow type flowmeter according to the second embodiment of the present disclosure.

FIG. 9 is a cross-sectional view illustrating a state of mounting the sensor chip of the laminar type flowmeter on a diaphragm base according to the second embodiment of the present disclosure.

FIG. 10 is a plan view of a sensor package of a laminar flow type flowmeter according to a third embodiment of the present disclosure.

FIG. 11 is a cross-sectional view of the laminar flow type flowmeter according to the third embodiment of the present disclosure.

FIG. 12 is a plan view of a sensor package of a laminar flow type flowmeter according to a fourth embodiment of the present disclosure.

FIG. 13 is a cross-sectional view of the laminar flow type flowmeter according to the fourth embodiment of the present disclosure.

FIG. 14 is a block diagram illustrating an example of configurations of a computer that realizes the laminar flow type flowmeters according to the first to fourth embodiments of the present disclosure.

FIG. 15 is a diagram illustrating configurations of a conventional laminar flow type flowmeter.

FIG. 16 is a diagram illustrating other configurations of the conventional laminar flow type flowmeter.

FIG. 17 is a plan view of an absolute pressure sensor.

FIG. 18 is a cross-sectional view of the absolute pressure sensor.

### DETAILED DESCRIPTION OF THE INVENTION

### First Embodiment

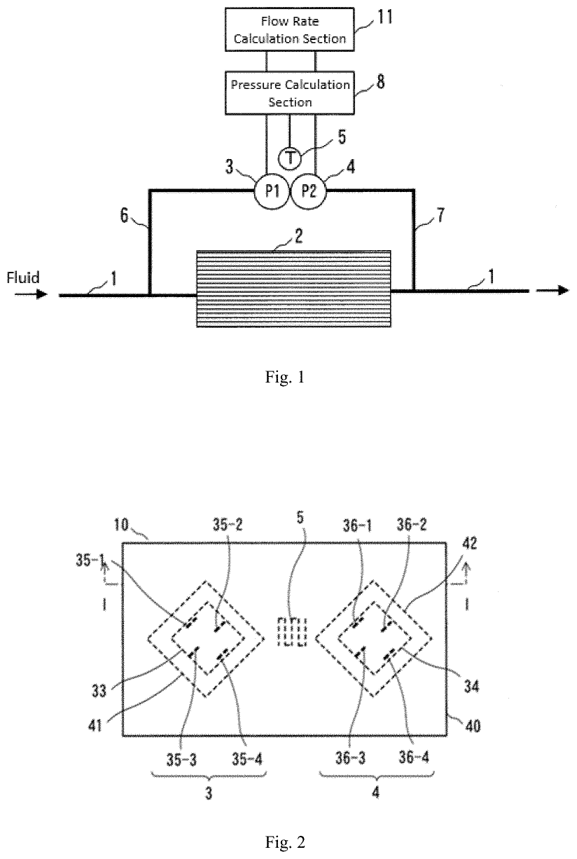

Embodiments of the present disclosure will be described below with reference to the drawings. FIG. 1 is a diagram illustrating configurations of a laminar flow type flowmeter (differential pressure type flowmeter) according to a first embodiment of the present disclosure. The laminar flow type flowmeter is configured with a pipe 1 circulating a fluid to be measured, a laminar flow element 2 installed within the pipe 1 and serving as a differential pressure generation mechanism that generates a differential pressure between an upstream fluid and a downstream fluid, an absolute pressure sensor 3 that measures an absolute pressure P1 of the fluid upstream of the laminar flow element 2, an absolute pressure sensor 4 that measures an absolute pressure P2 of the fluid downstream of the laminar flow element 2, a temperature sensor 5 that measures an ambient temperature of the absolute pressure sensors 3 and 4, conduits 6 and 7 that guide the fluid to the absolute pressure sensors 3 and 4, a pressure calculation section 8 that corrects an output signal from the absolute pressure sensor 3 on the basis of a temperature T measured by the temperature sensor 5 to be converted into the absolute pressure P1, and that corrects an output signal from the absolute pressure sensor 4 on the basis of the temperature T to be converted into the absolute pressure P2, and a flow rate calculation section 11 that calculates a flow rate of the fluid on the basis of the absolute pressures P1 and P2 calculated by the pressure calculation section 8.

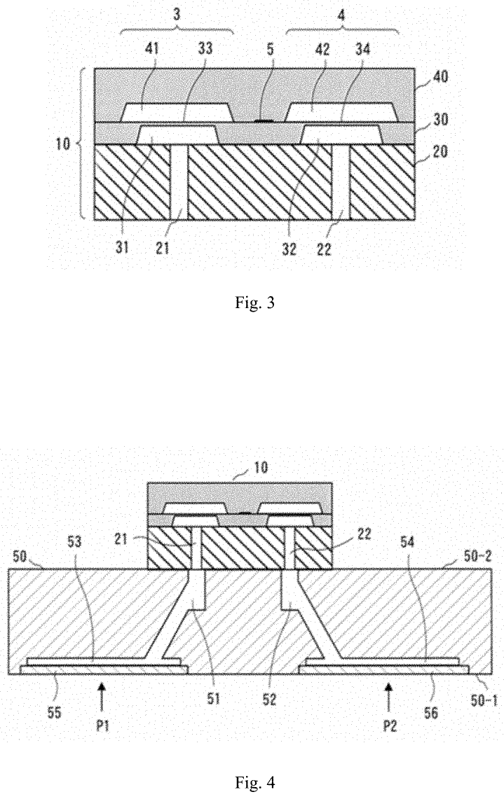

FIG. 2 is a plan view of a sensor chip mounting thereon the absolute pressure sensors 3 and 4 and the temperature sensor 5, and FIG. 3 is a cross-sectional view taken along line I-I of FIG. 2.

A sensor chip 10 is configured from a planar pedestal 20 formed from glass, a planar pressure-sensitive member 30 bonded with the pedestal 20 and formed from silicon, and a planar lid member 40 bonded with the pressure-sensitive member 30 and formed from silicon.

Two through-holes 21 and 22 that serve as pressure guidance paths penetrating the pedestal 20 from a rear surface (lower surface) to a front surface (upper surface) are formed in the pedestal 20.

Two recess portions 31 and 32 that are squares in a plan view and that are formed by removing a rear surface side of the pressure-sensitive member 30 so that a front surface side thereof remains are formed in a rear surface of the pressure-sensitive member 30 facing the pedestal 20. Parts remaining on the front surface side of regions where the recess portions 31 and 32 of the pressure-sensitive member 30 are formed serve as a diaphragm 33 of the absolute pressure sensor 3 and a diaphragm 34 of the absolute pressure sensor 4.

Furthermore, strain gauges 35-1 to 35-4 and 36-1 to 36-4 that function as piezoresistance elements by, for example, an impurity diffusion or ion implantation technique are formed in peripheral edge portions of the diaphragms 33 and 34 formed on front surface sides of the regions of the recess portions 31 and 32 out of a front surface of the pressure-sensitive member 30 facing the lid member 40.

Moreover, a temperature sensor 5 formed from a metallic thin film heat-sensitive resistive element is formed on the front surface of the pressure-sensitive member 30 facing the lid member 40.

Two recess portions 41 and 42 (pressure reference chambers) that are squares in a plan view and that are formed by removing a rear surface side of the lid member 40 so that a front side thereof remains are formed in a rear surface of the lid member 40 facing the pressure-sensitive member 30 at positions at which the diaphragms 33 and 34 are covered with the recess portions 41 and 42 when the pressure-sensitive member 30 and the lid member 40 are bonded with each other.

Needless to say, the through-holes 21 and 22 and the recess portions 31, 32, 41, and 42 can be easily formed by an etching technique. Likewise, through-holes and recess portions in subsequent embodiments can be easily formed by the etching technique.

The pedestal 20 and the pressure-sensitive member 30 are bonded with each other by direct bonding so that the through-holes 21 and 22 of the pedestal 20 are in communication with the recess portions 31 and 32 of the pressure-sensitive member 30.

The pressure-sensitive member 30 and the lid member 40 are bonded with each other by direct bonding so that the diaphragms 33 and 34 of the pressure-sensitive member 30 are covered with the recess portions 41 and 42 of the lid member 40.

The sensor chip 10 is mounted on a diaphragm base. FIG. 4 illustrates a cross-sectional view of a state of mounting the sensor chip 10 on the diaphragm base.

A diaphragm base 50 is formed from a metal material for guiding a pressure of the fluid to be measured to the sensor chip 10. As an example of the metal material, a stainless steel (SUS) can be cited. As illustrated in FIG. 4, the diaphragm base 50 has a principal surface 50-1 and a principal surface 50-2 opposite to the principal surface 50-1. Through-holes 51 and 52 penetrating the principal surfaces 50-1 and 50-2 are formed in the diaphragm base 50. Two recess portions 53 and 54 are formed in opening portions of the through-holes 51 and 52 closer to the principal surface 50-1. The recess portion 53 is covered with a barrier diaphragm 55 that directly receives the fluid upstream of the laminar flow element 2. Likewise, the recess portion 54 is covered with a barrier diaphragm 56 that directly receives the fluid downstream of the laminar flow element 2. The barrier diaphragms 55 and 56 are configured from, for example, stainless steel (SUS).

The sensor chip 10 and the diaphragm base 50 are bonded with each other by an adhesive so that the through-holes 21 and 22 of the sensor chip 10 are in communication with the through-holes 51 and 52 of the diaphragm base 50.

The fluid upstream of the laminar flow element 2 is guided to the barrier diaphragm 55 via the conduit 6. The fluid downstream of the laminar flow element 2 is guided to the barrier diaphragm 56 via the conduit 7. The recess portion 53 and the through-hole 51 of the diaphragm base 50 and the through-hole 21 and the recess portion 31 of the sensor chip 10 configure a first pressure guidance path. A first enclosed liquid is enclosed in the first pressure guidance path. The recess portion 54 and the through-hole 52 of the diaphragm base 50 and the through-hole 22 and the recess portion 32 of the sensor chip 10 configure a second pressure guidance path. A second enclosed liquid is enclosed in the second pressure guidance path. The first enclosed liquid transmits the pressure P1 applied to the barrier diaphragm 55 to a lower surface of the diaphragm 33 of the absolute pressure sensor 3. The second enclosed liquid transmits the pressure P2 applied to the barrier diaphragm 56 to a lower surface of the diaphragm 34 of the absolute pressure sensor 4. The recess portions 41 and 42 of the sensor chip 10 are sealed in a vacuum state.

Although not illustrated in FIGS. 2 and 3, the strain gauges 35-1 to 35-4 and 36-1 to 36-4 can be connected to an external circuit by forming eight electrode pads electrically connected to the strain gauges 35-1 to 35-4 and 36-1 to 36-4, respectively, on an exposed surface of the pressure-sensitive member 30.

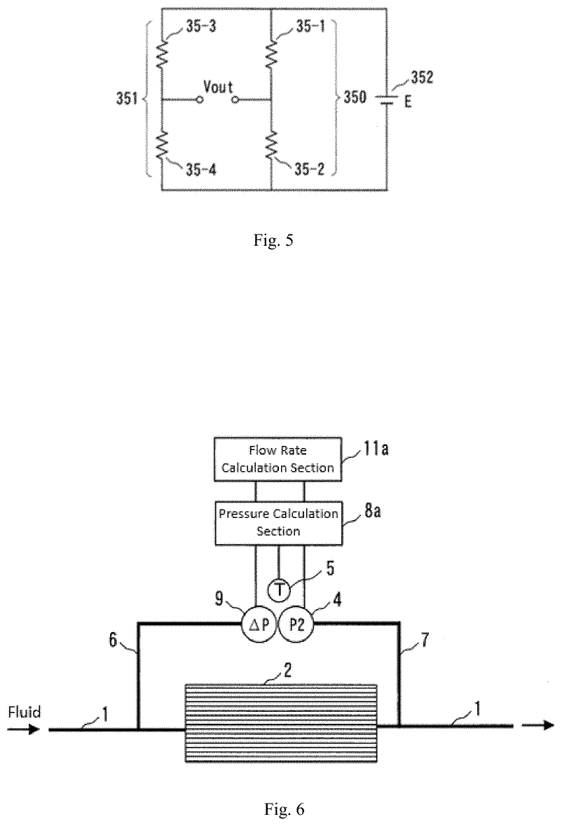

The strain gauges 35-1 to 35-4 of the absolute pressure sensor 3 configure together with the external circuit a first absolute-pressure-measurement Wheatstone bridge circuit as illustrated in FIG. 5. The Wheatstone bridge circuit of FIG. 5 is configured in such a manner that the first strain gauge 35-1 and the second strain gauge 35-2 at a position adjacent to the first strain gauge 35-1 are connected in series to configure a first series circuit 350, the third strain gauge 35-3 at a position adjacent to the first strain gauge 35-1 and the fourth strain gauge 35-4 at a position opposed to the first strain gauge 35-1 are connected in series to configure a second series circuit 351, and a Wheatstone bridge drive voltage E is applied to both ends of the first series circuit 350 and both ends of the second series circuit 351 by a power supply 352. An output signal Vout indicating a displacement of the diaphragm 33 in response to the absolute pressure P1 applied to the lower surface of the diaphragm 33 is output from between a connection point between the strain gauges 35-1 and 35-2 and a connection point between the strain gauges 35-3 and 35-4.

The strain gauges 36-1 to 36-4 of the absolute pressure sensor 4 configure together with the external circuit a second absolute-pressure-measurement Wheatstone bridge circuit. The second absolute-pressure-measurement Wheatstone bridge circuit corresponds to the Wheatstone bridge circuit in which the strain gauges 35-1 to 35-4 in FIG. 5 are replaced by the strain gauges 36-1 to 36-4. That is, an output signal Vout indicating a displacement of the diaphragm 34 in response to the absolute pressure P2 applied to the lower surface of the diaphragm 34 is output from between a connection point between the strain gauges 36-1 and 36-2 (corresponding to the connection point between the strain gauges 35-1 and 35-2 of FIG. 5) and a connection point between the strain gauges 36-3 and 36-4 (corresponding to the connection point between the strain gauges 35-3 and 35-4 of FIG. 5).

Resistance values of the strain gauges 35-1 to 35-4 and 36-1 to 36-4 change with temperature. The pressure calculation section 8, therefore, corrects the output signal from the absolute pressure sensor 3 (output signal from the Wheatstone bridge circuit of the absolute pressure sensor 3) on the basis of the temperature T measured by the temperature sensor 5 to be converted into the absolute pressure P1, and corrects the output signal from the absolute pressure sensor 4 (output signal from the Wheatstone bridge circuit of the absolute pressure sensor 4) on the basis of the temperature T to be converted into the absolute pressure P2. A correction equation with the temperature T used as a variable or a table that stores the temperature T, the output signals from the absolute pressure sensors 3 and 4, and the absolute pressures P1 and P2 to be associated with one another is set to the pressure calculation section 8 in advance. The pressure calculation section 8 converts the output signal from the absolute pressure sensor 3 into the absolute pressure P1 and converts the output signal from the absolute pressure sensor 4 into the absolute pressure P2 by either the correction equation or the table. In doing so, it is possible to correct the output signals from the absolute pressure sensors 3 and 4 and convert the output signals into the absolute pressures P1 and P2.

The flow rate calculation section 11 calculates a flow rate Q of the fluid to be measured on the basis of the absolute pressures P1 and P2 calculated by the pressure calculation section 8.

Q=K=(P1²−P2²) (2)

In Equation (2), K denotes a constant associated with a physical property of the fluid to be measured and a flow path shape. It is noted that Equation (2) is an equation on the premise of using the laminar flow element 2 as the differential pressure generation mechanism.

As described so far, in the present embodiment, the pressure detection diaphragms 33 and 34 for detecting the two absolute pressures P1 and P2 and the temperature sensor 5 are integrated in one chip, thereby making it possible to diminish a difference in temperature between the absolute pressure sensors 3 and 4. Furthermore, in the present embodiment, the two pressure detection diaphragms 33 and 34 are integrated in one chip, thereby making it possible to reduce characteristic irregularities between the diaphragms 33 and 34. As a result, in the present embodiment, it is possible to reduce flow rate measurement errors of the laminar flow type flowmeter.

### Second Embodiment

A second embodiment of the present disclosure will next be described. FIG. 6 is a diagram illustrating configurations of a laminar flow type flowmeter (differential pressure type flowmeter) according to the second embodiment of the present disclosure. The laminar flow type flowmeter in the present embodiment is configured with the pipe 1, the laminar flow element 2, a differential pressure sensor 9 that measures a differential pressure ΔP between the fluid upstream of the laminar flow element 2 and the fluid downstream thereof, the absolute pressure sensor 4 that measures the absolute pressure P2 of the fluid downstream of the laminar flow element 2, the temperature sensor 5, the conduits 6 and 7, a pressure calculation section 8a that corrects an output signal from the differential pressure sensor 9 on the basis of the temperature T measured by the temperature sensor 5 to be converted into the differential pressure ΔP, and that corrects an output signal from the absolute pressure sensor 4 on the basis of the temperature T to be converted into the absolute pressure P2, and a flow rate calculation section 11a that calculates a flow rate of the fluid on the basis of the differential pressure ΔP and the absolute pressure P2 calculated by the pressure calculation section 8a.

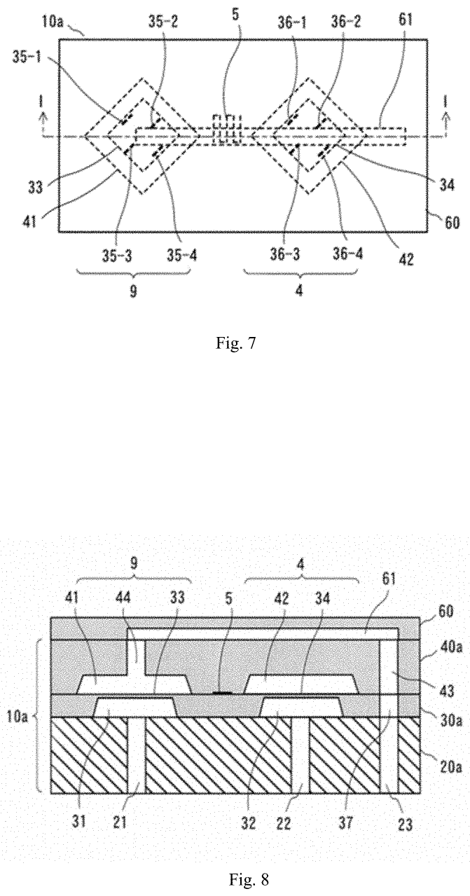

FIG. 7 is a plan view of a sensor chip mounting thereon the differential pressure sensor 9, the absolute pressure sensor 4, and the temperature sensor 5, and FIG. 8 is a cross-sectional view taken along line I-I of FIG. 7.

A sensor chip 10a in the present embodiment is configured from a planar pedestal 20a formed from glass, a planar pressure-sensitive member 30a bonded with the pedestal 20a and formed from silicon, a planar lid member 40a bonded with the pressure-sensitive member 30a and formed from silicon, and a planar flow path member 60 bonded with the lid member 40a and formed from silicon.

Three through-holes 21, 22, and 23 that serve as pressure guidance paths penetrating the pedestal 20a from a rear surface (lower surface) to a front surface (upper surface) are formed in the pedestal 20a.

A through-hole 37 that serves as a pressure guidance path penetrating the pressure-sensitive member 30a from a rear surface to a front surface is formed in the pressure-sensitive member 30a at a position at which the through-hole 37 is in communication with the through-hole 23. Similarly to the first embodiment, two recess portions 31 and 32 that are squares in the plan view are formed in the rear surface of the pressure-sensitive member 30a facing the pedestal 20a. The parts remaining on the front surface side of regions where the recess portions 31 and 32 of the pressure-sensitive member 30a are formed serve as the diaphragm 33 of the differential pressure sensor 9 and the diaphragm 34 of the absolute pressure sensor 4.

Similarly to the first embodiment, the strain gauges 35-1 to 35-4 and 36-1 to 36-4 are formed in the peripheral edge portions of the diaphragms 33 and 34 formed on the front surface sides of the regions of the recess portions 31 and 32 out of the front surface of the pressure-sensitive member 30a facing the lid member 40a. Moreover, the temperature sensor 5 is formed on the front surface of the pressure-sensitive member 30a facing the lid member 40a.

A through-hole 43 that serves as a pressure guidance path penetrating the lid member 40a from a rear surface to a front surface is formed in the lid member 40a at a position at which the through-hole 43 is in communication with the through-hole 37 when the pressure-sensitive member 30a and the lid member 40a are bonded with each other. Similarly to the first embodiment, two recess portions 41 and 42 that are squares in the plan view are formed in a rear surface of the lid member 40a facing the pressure-sensitive member 30a at the positions at which the diaphragms 33 and 34 are covered with the recess portions 41 and 42 when the pressure-sensitive member 30a and the lid member 40a are bonded with each other. The recess portion 41 serves as a pressure guidance chamber of the differential pressure sensor 9, and the recess portion 42 serves as a pressure reference chamber of the absolute pressure sensor 4. Moreover, a through-hole 44 that serves as a pressure guidance path penetrating the lid member 40a from the front surface to the recess portion 41 is formed in the lid member 40a.

A groove 61 having one end in communication with the through-hole 43 and the other end in communication with the through-hole 44 when the lid member 40a and the flow path member 60 are bonded with each other is formed in a rear surface of the flow path member 60 facing the lid member 40a.

The pedestal 20a and the pressure-sensitive member 30a are bonded with each other by direct bonding so that the through-holes 21 and 22 of the pedestal 20a are in communication with the recess portions 31 and 32 of the pressure-sensitive member 30a and so that the through-hole 23 of the pedestal 20a is in communication with the through-hole 37 of the pressure-sensitive member 30a.

The pressure-sensitive member 30a and the lid member 40a are bonded with each other by direct bonding so that the diaphragms 33 and 34 of the pressure-sensitive member 30a are covered with the recess portions 41 and 42 of the lid member 40a and so that the through-hole 37 of the pressure-sensitive member 30a is in communication with the through-hole 43 of the lid member 40a.

The lid member 40a and the flow path member 60 are bonded with each other by direct bonding so that one end of the groove 61 of the flow path member 60 is in communication with the through-hole 43 of the lid member 40a and the other end of the groove 61 is in communication with the through-hole 44 of the lid member 40a.

The through-hole 21 and the recess portion 31 configure a first pressure guidance path that transmits the pressure P1 to the lower surface of the diaphragm 33. The through-holes 23, 37, and 43, the groove 61, the through-hole 44, and the recess portion 41 configure a second pressure guidance path that transmits the pressure P2 to the upper surface of the diaphragm 33. The through-hole 22 and the recess portion 32 configure a third pressure guidance path that transmits the pressure P2 to the lower surface of the diaphragm 34.

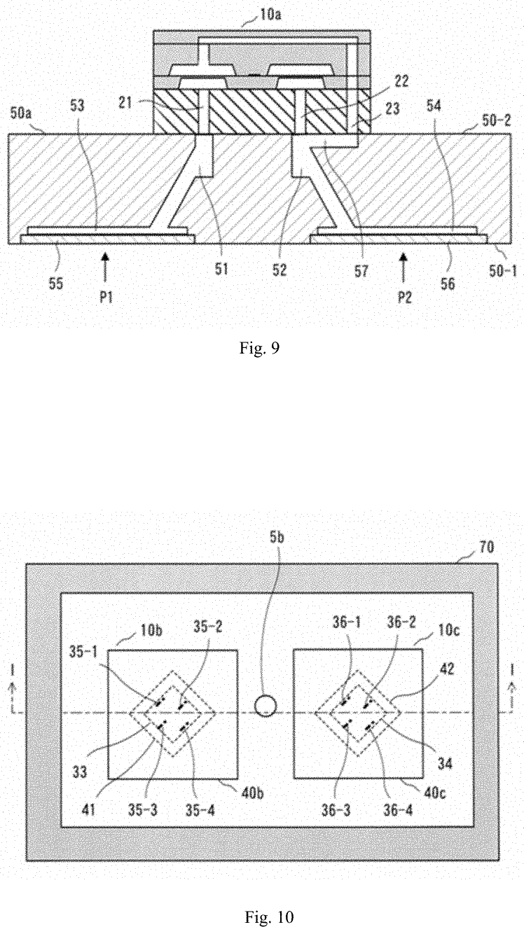

The sensor chip 10a is mounted on a diaphragm base. FIG. 9 illustrates a cross-sectional view of a state of mounting the sensor chip 10a on the diaphragm base. The diaphragm base 50a is similar in configurations to the diaphragm base 50 in the first embodiment. Furthermore, a groove 57 having one end in communication with the through-hole 52 is formed in the principal surface 50-2 of the diaphragm base 50a.

The sensor chip 10a and the diaphragm base 50a are bonded with each other by an adhesive so that the through-holes 21 and 22 of the sensor chip 10a are in communication with the through-holes 51 and 52 of the diaphragm base 50a and so that the through-hole 23 of the sensor chip 10a is in communication with the groove 57 of the diaphragm base 50a.

Similarly to the first embodiment, the fluid upstream of the laminar flow element 2 is guided to the barrier diaphragm 55 via the conduit 6. The fluid downstream of the laminar flow element 2 is guided to the barrier diaphragm 56 via the conduit 7. The first enclosed liquid is enclosed in the recess portion 53 and the through-hole 51 of the diaphragm base 50a and the through-hole 21 and the recess portion 31 of the sensor chip 10a. The second enclosed liquid is enclosed in the recess portion 54, the through-hole 52, and the groove 57 of the diaphragm base 50a and the through-holes 22 and 23, the recess portion 32, the through-holes 37 and 43, the groove 61, the through-hole 44, and the recess portion 41 of the sensor chip 10a. The first enclosed liquid transmits the pressure P1 applied to the barrier diaphragm 55 to the lower surface of the diaphragm 33 of the differential pressure sensor 9. The second enclosed liquid transmits the pressure P2 applied to the barrier diaphragm 56 to an upper surface of the diaphragm 33 of the differential pressure sensor 9 and the lower surface of the diaphragm 34 of the absolute pressure sensor 4. The recess portion 42 of the sensor chip 10a is sealed in a vacuum state.

The strain gauges 35-1 to 35-4 of the differential pressure sensor 9 configure together with the external circuit a differential-pressure-measurement Wheatstone bridge circuit. The differential-pressure-measurement Wheatstone bridge circuit is similar in configurations to the circuit illustrated in FIG. 5. That is, the output signal Vout indicating a displacement of the diaphragm 33 in response to the differential pressure ΔP (=P1−P2) is output from between the connection point between the strain gauges 35-1 and 35-2 and the connection point between the strain gauges 35-3 and 35-4.

The pressure calculation section 8a corrects an output signal from the differential pressure sensor 9 (output signal from the Wheatstone bridge circuit of the differential pressure sensor 9) to be converted into the differential pressure ΔP using the correction equation with the temperature T used as a variable or the table that stores the temperature T, the output signals from the differential pressure sensor 9, and the differential pressure ΔP to be associated with one another. Furthermore, similarly to the pressure calculation section 8 in the first embodiment, the pressure calculation section 8a corrects the output signal from the absolute pressure sensor 4 on the basis of the temperature T to be converted into the absolute pressure P2.

The flow rate calculation section 11a calculates the flow rate Q of the fluid to be measured on the basis of the differential pressure ΔP and the absolute pressure P2 calculated by the pressure calculation section 8a.

Q=K=(ΔP+2×P2)×ΔP (3)

In Equation (3), K denotes the constant associated with the physical property of the fluid to be measured and the flow path shape. Similarly to Equation (2), Equation (3) is an equation on the premise of using the laminar flow element 2 as the differential pressure generation mechanism.

As described so far, in the present embodiment, the pressure detection diaphragms 33 and 34 for detecting the differential pressure ΔP and the absolute pressure P2 and the temperature sensor 5 are integrated in one chip, thereby making it possible to attain similar advantages to those of the first embodiment.

### Third Embodiment

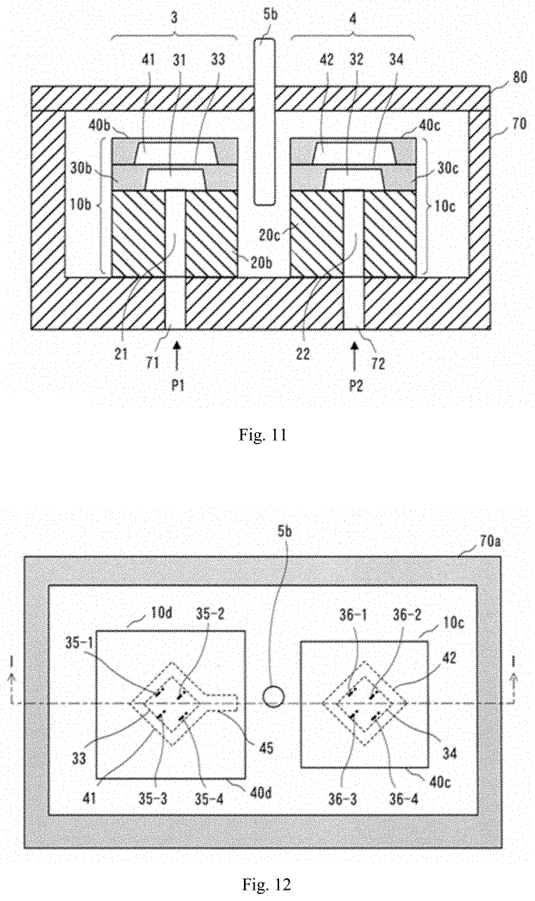

While the two pressure detection diaphragms and the temperature sensor are integrated in one chip in the first and second embodiments, the two pressure detection diaphragms and the temperature sensor may be accommodated in the same package. FIG. 10 is a plan view of a sensor package of a laminar flow type flowmeter (differential pressure type flowmeter) according to a third embodiment of the present disclosure, and FIG. 11 is a cross-sectional view taken along line I-I of FIG. 10. For easiness to view the structure, FIG. 10 illustrates an interior of the sensor package as a perspective view.

The pipe 1, the laminar flow element 2, the conduits 6 and 7, the pressure calculation section 8, and the flow rate calculation section 11 are already described in the first embodiment, and a laminar flow type flowmeter according to the present embodiment corresponds to the laminar flow type flowmeter in which the temperature sensor 5 is replaced by a temperature sensor 5b in FIG. 1.

For example, a sensor chip 10b of the absolute pressure sensor 3 and a sensor chip 10c of the absolute pressure sensor 4 are accommodated in a ceramic sensor package 70.

The sensor chip 10b of the absolute pressure sensor 3 is configured from a planar pedestal 20b formed from glass, a planar pressure-sensitive member 30b bonded with the pedestal 20b and formed from silicon, and a planar lid member 40b bonded with the pressure-sensitive member 30b and formed from silicon.

The through-hole 21 that serves as the pressure guidance path penetrating the pedestal 20b from a rear surface to a front surface is formed in the pedestal 20b.

The recess portion 31 (pressure guidance chamber) that is a square in the plan view is formed in a rear surface of the pressure-sensitive member 30b facing the pedestal 20b. The part remaining on the front surface side of the region where the recess portion 31 of the pressure-sensitive member 30b is formed serves as the diaphragm 33 of the absolute pressure sensor 3.

Furthermore, the strain gauges 35-1 to 35-4 are formed in the peripheral edge portions of the diaphragm 33 formed on the front surface side of the region of the recess portion 31 out of the front surface of the pressure-sensitive member 30b facing the lid member 40b.

The recess portion 41 (pressure reference chamber) that is a square in the plan view is formed in the rear surface of the lid member 40b facing the pressure-sensitive member 30b at the position at which the diaphragm 33 is covered with the recess portion 41 when the pressure-sensitive member 30b and the lid member 40b are bonded with each other.

The pedestal 20b and the pressure-sensitive member 30b are bonded with each other by direct bonding so that the through-hole 21 of the pedestal 20b is in communication with the recess portion 31 of the pressure-sensitive member 30b. The pressure-sensitive member 30b and the lid member 40b are bonded with each other by direct bonding so that the diaphragm 33 of the pressure-sensitive member 30b is covered with the recess portion 41 of the lid member 40b.

The through-hole 21 and the recess portion 31 configure a first pressure guidance path that transmits the pressure P1 to the lower surface of the diaphragm 33.

On the other hand, the sensor chip 10c is configured from a planar pedestal 20c formed from glass, a planar pressure-sensitive member 30c bonded with the pedestal 20c and formed from silicon, and a planar lid member 40c bonded with the pressure-sensitive member 30c and formed from silicon.

The through-hole 22 that serves as the pressure guidance path penetrating the pedestal 20c from a rear surface to a front surface is formed in the pedestal 20c.

The recess portion 32 (pressure guidance chamber) that is a square in the plan view is formed in a rear surface of the pressure-sensitive member 30c facing the pedestal 20c. The part remaining on the front surface side of the region where the recess portion 32 of the pressure-sensitive member 30c is formed serves as the diaphragm 34 of the absolute pressure sensor 4.

Furthermore, the strain gauges 36-1 to 36-4 are formed in the peripheral edge portions of the diaphragm 34 formed on the front surface side of the region of the recess portion 32 out of the front surface of the pressure-sensitive member 30c facing the lid member 40c.

The recess portion 42 (pressure reference chamber) that is a square in the plan view is formed in the rear surface of the lid member 40c facing the pressure-sensitive member 30c at the position at which the diaphragm 34 is covered with the recess portion 42 when the pressure-sensitive member 30c and the lid member 40c are bonded with each other.

The pedestal 20c and the pressure-sensitive member 30c are bonded with each other by direct bonding so that the through-hole 22 of the pedestal 20c is in communication with the recess portion 32 of the pressure-sensitive member 30c. The pressure-sensitive member 30c and the lid member 40c are bonded with each other by direct bonding so that the diaphragm 34 of the pressure-sensitive member 30c is covered with the recess portion 42 of the lid member 40c.

The through-hole 22 and the recess portion 32 configure a first pressure guidance path that transmits the pressure P2 to the lower surface of the diaphragm 34.

Through-holes 71 and 72 are formed in a bottom surface of the sensor package 70. The sensor chips 10b and 10c and the sensor package 70 are bonded with one another by an adhesive so that the through-holes 21 and 22 of the sensor chips 10b and 10c are in communication with the through-holes 71 and 72 of the sensor package 70.

The temperature sensor 5b is attached to a metal lid 80 so that a temperature detection section (lower end of the temperature sensor 5b of FIG. 11) can be accommodated in the sensor package 70 when, for example, the lid 80 is bonded with the sensor package 70.

The first enclosed liquid is enclosed in the through-hole 71 of the sensor package 70 and the through-hole 21 and the recess portion 31 of the sensor chip 10b. The second enclosed liquid is enclosed in the through-hole 72 of the sensor package 70 and the through-hole 22 and the recess portion 32 of the sensor chip 10c. The first enclosed liquid transmits the pressure P1 of the fluid upstream of the laminar flow element 2 to the lower surface of the diaphragm 33 of the absolute pressure sensor 3. The second enclosed liquid transmits the pressure P2 of the fluid downstream of the laminar flow element 2 to the lower surface of the diaphragm 34 of the absolute pressure sensor 4. The recess portions 41 and 42 of the sensor chips 10b and 10c are sealed in a vacuum state. Similarly to the first embodiment, the sensor package 70 may be mounted on a diaphragm base.

The Wheatstone bridge circuits of the absolute pressure sensors 3 and 4 measuring the absolute pressures P1 and P2 are already described in the first embodiment.

As described so far, in the present embodiment, the two sensor chips 10b and 10c and the temperature sensor 5b are accommodated in one package, thereby making it possible to attain similar advantages to those of the first embodiment.

### Fourth Embodiment

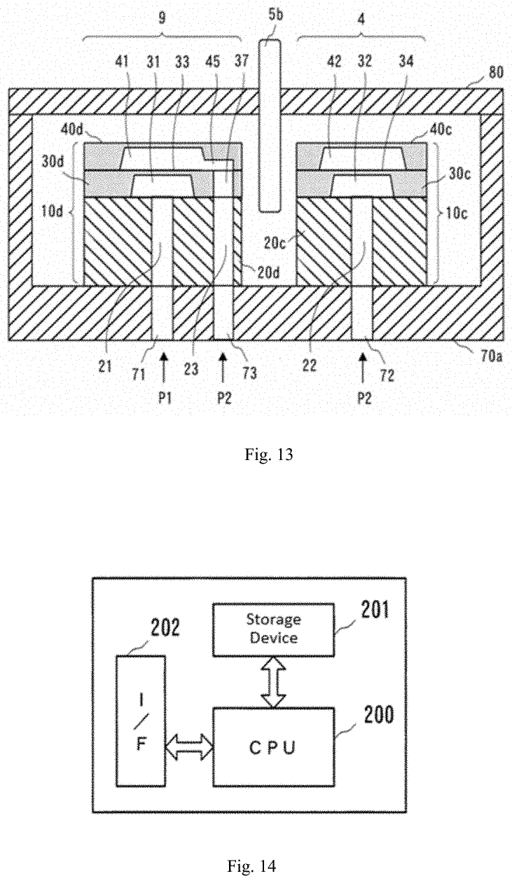

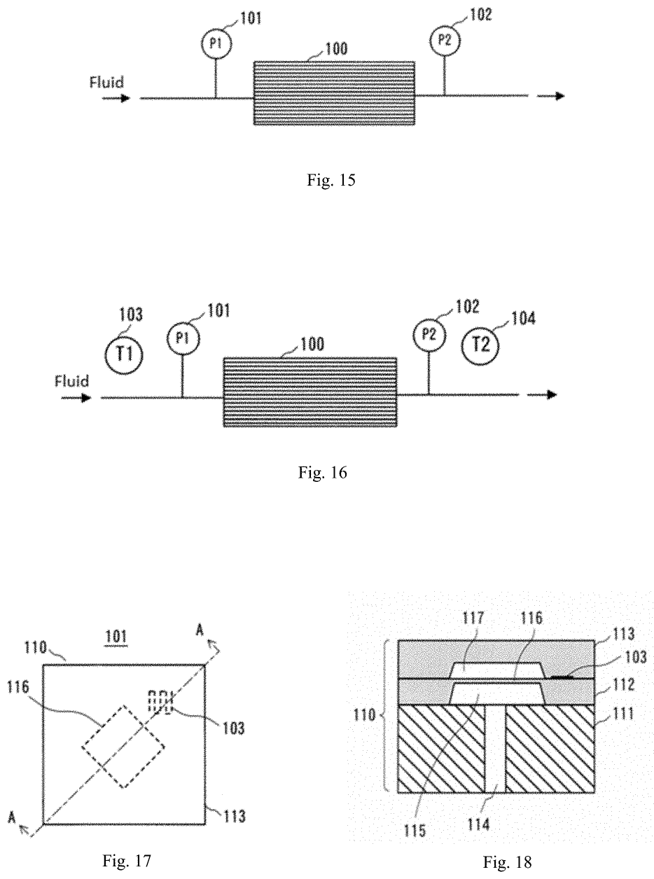

A fourth embodiment of the present disclosure will next be described. FIG. 12 is a plan view of a sensor package of a laminar flow type flowmeter (differential pressure type flowmeter) according to the fourth embodiment of the present disclosure, and FIG. 13 is a cross-sectional view taken along line I-I of FIG. 12. For easiness to view a structure, FIG. 12 illustrates an interior of the sensor package as a perspective view.

The pipe 1, the laminar flow element 2, the conduits 6 and 7, the pressure calculation section 8a, and the flow rate calculation section 11a are already described in the second embodiment, and a laminar flow type flowmeter according to the present embodiment corresponds to the laminar flow type flowmeter in which the temperature sensor 5 is replaced by the temperature sensor 5b in FIG. 6.

For example, a sensor chip 10d of the differential pressure sensor 9 and the sensor chip 10c of the absolute pressure sensor 4 are accommodated in a ceramic sensor package 70a.

The sensor chip 10d of the differential pressure sensor 9 is configured from a planar pedestal 20d formed from glass, a planar pressure-sensitive member 30d bonded with the pedestal 20d and formed from silicon, and a planar lid member 40d bonded with the pressure-sensitive member 30d and formed from silicon.

The through-holes 21 and 23 that serve as the pressure guidance paths penetrating the pedestal 20d from a rear surface to a front surface are formed in the pedestal 20d.

The recess portion 31 (pressure guidance chamber) that is a square in the plan view is formed in a rear surface of the pressure-sensitive member 30d facing the pedestal 20d. The part remaining on the front surface side of the region where the recess portion 31 of the pressure-sensitive member 30d is formed serves as the diaphragm 33 of the differential pressure sensor 9.

Furthermore, the strain gauges 35-1 to 35-4 are formed in the peripheral edge portions of the diaphragm 33 formed on the front surface side of the region of the recess portion 31 out of the front surface of the pressure-sensitive member 30d facing the lid member 40d. Moreover, the through-hole 37 that serves as a pressure guidance path penetrating the pressure-sensitive member 30d from a rear surface to a front surface is formed in the pressure-sensitive member 30d at a position at which the through-hole 37 is in communication with the through-hole 23 when the pedestal 20d and the pressure-sensitive member 30d are bonded with each other.

The recess portion 41 (pressure reference chamber) that is a square in the plan view is formed in the rear surface of the lid member 40d facing the pressure-sensitive member 30d at the position at which the diaphragm 33 is covered with the recess portion 41 when the pressure-sensitive member 30d and the lid member 40d are bonded with each other. Furthermore, a groove 45 having one end in communication with the recess portion 41 and serving as a pressure guidance path in communication with the through-hole 37 when the pressure-sensitive member 30d and the lid member 40d are bonded with each other is formed in a rear surface of the lid member 40d.

The pedestal 20d and the pressure-sensitive member 30d are bonded with each other by direct bonding so that the through-hole 21 of the pedestal 20d is in communication with the recess portion 31 of the pressure-sensitive member 30d and so that the through-hole 23 of the pedestal 20d is in communication with the through-hole 37 of the pressure-sensitive member 30d. The pressure-sensitive member 30d and the lid member 40d are bonded with each other by direct bonding so that the through-hole 37 of the pressure-sensitive member 30d is in communication with the groove 45 of the lid member 40d and so that the diaphragm 33 of the pressure-sensitive member 30d are covered with the recess portion 41 of the lid member 40d.

The through-hole 21 and the recess portion 31 configure the first pressure guidance path that transmits the pressure P1 to the lower surface of the diaphragm 33. The through-holes 23 and 37, the groove 45, and the recess portion 41 configure the second pressure guidance path that transmits the pressure P2 to the upper surface of the diaphragm 33.

The sensor chip 10c of the absolute pressure sensor 4 is already described in the third embodiment.

Through-holes 71 to 73 are formed in a bottom surface of the sensor package 70a. The sensor chips 10c and 10d and the sensor package 70a are bonded with one another by an adhesive so that the through-holes 21 and 23 of the sensor chip 10d are in communication with the through-holes 71 and 73 of the sensor package 70a and so that the through-hole 22 of the sensor chip 10c is in communication with the through-hole 72 of the sensor package 70a.

As described in the third embodiment, the temperature sensor 5b is attached to the lid 80.

The first enclosed liquid is enclosed in the through-hole 71 of the sensor package 70a and the through-hole 21 and the recess portion 31 of the sensor chip 10d. The second enclosed liquid is enclosed in the through-holes 72 and 73 of the sensor package 70a, the through-hole 22 and the recess portion 32 of the sensor chip 10c, and the through-holes 23 and 37, the groove 45, and the recess portion 41 of the sensor chip 10d. The first enclosed liquid transmits the pressure P1 of the fluid upstream of the laminar flow element 2 to the lower surface of the diaphragm 33 of the differential pressure sensor 9. The second enclosed liquid transmits the pressure P2 of the fluid downstream of the laminar flow element 2 to the upper surface of the diaphragm 33 of the differential pressure sensor 9 and the lower surface of the diaphragm 34 of the absolute pressure sensor 4. The recess portion 42 of the sensor chip 10c is sealed in a vacuum state. Similarly to the second embodiment, the sensor package 70a may be mounted on a diaphragm base.

The Wheatstone bridge circuit of the differential pressure sensor 9 measuring the differential pressure ΔP and the Wheatstone bridge circuit of the absolute pressure sensor 4 measuring the absolute pressure P2 are already described in the second embodiment.

As described so far, in the present embodiment, the two sensor chips 10c and 10d and the temperature sensor 5b are accommodated in the same package, thereby making it possible to attain similar advantages to those of the second embodiment.

While the laminar flow element 2 is used as the differential pressure generation mechanism in the first to fourth embodiments, other differential pressure generation mechanisms such as an orifice plate or a pitot tube may be used.

Furthermore, while the pressure sensor of the semiconductor piezoresistance scheme is used in the first to fourth embodiments, the scheme is not limited to this semiconductor piezoresistance scheme, and a pressure sensor of the capacitance scheme that measures displacement amounts of the diaphragms 33 and 34 as changes in capacitance and that converts the displacement amounts into pressures may be used.

The pressure calculation section 8 or 8a and the flow rate calculation section 11 or 11a described in the first to fourth embodiments can be realized by a computer configured with a CPU (Central Processing Unit), a storage device, and an interface, and a program that controls hardware resources of these constituent elements. FIG. 14 illustrates an example of configurations of this computer. The computer is configured with a CPU 200, a storage device 201, and an interface device (I/F) 202. Circuits of the sensors 3, 4, and 9, the temperature sensor 5 or 5b, and the like are connected to the I/F 202. A program for realizing a flow rate measurement method according to the present disclosure is stored in the storage device 201. The CPU 200 executes the processing described in the first to fourth embodiments in accordance with the program stored in the storage device 201.

The present disclosure is applicable to a differential pressure type flowmeter.

### DESCRIPTION OF REFERENCE NUMERALS AND SIGNS

1: pipe, 2: laminar flow element, 3, 4: absolute pressure sensor, 5, 5b: temperature sensor, 6, 7: conduit, 8, 8a: pressure calculation section, 9: differential pressure sensor, 10, 10a to 10d: sensor chip, 11, 11a: flow rate calculation section, 20, 20a to 20d: pedestal, 21-23, 37, 43, 44, 51, 52, 71, 72: through-hole, 30, 30a to 30d: pressure-sensitive member, 31, 32, 41, 42, 53, 54: recess portion, 33, 34: diaphragm, 35-1 to 35-4, 36-1 to 36-4: strain gauge, 38, 45, 57, 61: groove, 40, 40a to 40d: lid member, 50, 50a: diaphragm base, 55, 56: barrier diaphragm, 60: flow path member, 70, 70a: sensor package, 80: lid

1. A differential pressure type flowmeter comprising:
a pipe configured to circulate a fluid to be measured;
a differential pressure generation mechanism that is installed within the pipe and that is configured to generate a differential pressure between the fluid on an upstream side and the fluid on a downstream side;
a first absolute pressure sensor configured to measure a first absolute pressure of the fluid upstream of the differential pressure generation mechanism;
a second absolute pressure sensor configured to measure a second absolute pressure of the fluid downstream of the differential pressure generation mechanism;
a temperature sensor configured to measure an ambient temperature of the first and second absolute pressure sensors;
a pressure calculation section configured to correct an output signal from the first absolute pressure sensor on the basis of the temperature measured by the temperature sensor to be converted into the first absolute pressure, and configured to correct an output signal from the second absolute pressure sensor on the basis of the temperature measured by the temperature sensor to be converted into the second absolute pressure; and
a flow rate calculation section configured to calculate a flow rate of the fluid on the basis of the first and second absolute pressures calculated by the pressure calculation section;
wherein a diaphragm of the first absolute pressure sensor for receiving the first absolute pressure, a diaphragm of the second absolute pressure sensor for receiving the second absolute pressure, and the temperature sensor are integrated in one sensor chip.

2. The differential pressure type flowmeter according to claim 1, wherein
the diaphragm of the first absolute pressure sensor for receiving the first absolute pressure,
the diaphragm of the second absolute pressure sensor for receiving the second absolute pressure,
the temperature sensor,
a first pressure guidance path that transmits the first absolute pressure to the diaphragm of the first absolute pressure sensor, and
a second pressure guidance path that transmits the second absolute pressure to the diaphragm of the second absolute pressure sensor
are provided within the sensor chip.

3. A differential pressure type flowmeter comprising:
a pipe configured to circulate a fluid to be measured;
a differential pressure generation mechanism that is installed within the pipe and that is configured to generate a differential pressure between the fluid on an upstream side and the fluid on a downstream side;
a differential pressure sensor configured to measure a differential pressure between a first absolute pressure of the fluid upstream of the differential pressure generation mechanism and a second absolute pressure of the fluid downstream of the differential pressure generation mechanism;
an absolute pressure sensor configured to measure the second absolute pressure;
a temperature sensor configured to measure an ambient temperature of the differential pressure sensor and the absolute pressure sensor;
a pressure calculation section configured to correct an output signal from the differential pressure sensor on the basis of the temperature measured by the temperature sensor to be converted into the differential pressure, and configured to correct an output signal from the absolute pressure sensor on the basis of the temperature measured by the temperature sensor to be converted into the second absolute pressure; and
a flow rate calculation section configured to calculate a flow rate of the fluid on the basis of the differential pressure and the second absolute pressure calculated by the pressure calculation section;
wherein a diaphragm of the differential pressure sensor for receiving the first absolute pressure and the second absolute pressure, a diaphragm of the absolute pressure sensor for receiving the second absolute pressure, and the temperature sensor are integrated in one sensor chip.

4. The differential pressure type flowmeter according to claim 3, wherein
the diaphragm of the differential pressure sensor for receiving the first absolute pressure and the second absolute pressure,
the diaphragm of the absolute pressure sensor for receiving the second absolute pressure,
the temperature sensor,
a first pressure guidance path that transmits the first absolute pressure to a first surface of the diaphragm of the differential pressure sensor,
a second pressure guidance path that transmits the second absolute pressure to a second surface opposite to the first surface of the diaphragm of the differential pressure sensor, and
a third pressure guidance path that transmits the second absolute pressure to the diaphragm of the absolute pressure sensor
are provided within the sensor chip.

5. A differential pressure type flowmeter comprising:
a pipe configured to circulate a fluid to be measured;
a differential pressure generation mechanism that is installed within the pipe and that is configured to generate a differential pressure between the fluid on an upstream side and the fluid on a downstream side;
a first absolute pressure sensor configured to measure a first absolute pressure of the fluid upstream of the differential pressure generation mechanism;
a second absolute pressure sensor configured to measure a second absolute pressure of the fluid downstream of the differential pressure generation mechanism;
a temperature sensor configured to measure an ambient temperature of the first and second absolute pressure sensors;
a pressure calculation section configured to correct an output signal from the first absolute pressure sensor on the basis of the temperature measured by the temperature sensor to be converted into the first absolute pressure, and configured to correct an output signal from the second absolute pressure sensor on the basis of the temperature measured by the temperature sensor to be converted into the second absolute pressure; and
a flow rate calculation section configured to calculate a flow rate of the fluid on the basis of the first and second absolute pressures calculated by the pressure calculation section;
wherein a sensor chip of the first absolute pressure sensor, a sensor chip of the second absolute pressure sensor, and the temperature sensor are accommodated in one package.

6. The differential pressure type flowmeter according to claim 5,
wherein
a diaphragm of the first absolute pressure sensor for receiving the first absolute pressure, and
a first pressure guidance path that transmits the first absolute pressure to the diaphragm of the first absolute pressure sensor
are provided within the sensor chip of the first absolute pressure sensor, and
wherein
a diaphragm of the second absolute pressure sensor for receiving the second absolute pressure, and
a second pressure guidance path that transmits the second absolute pressure to the diaphragm of the second absolute pressure sensor
are provided within the sensor chip of the second absolute pressure sensor.

7. A differential pressure type flowmeter comprising:
a pipe configured to circulate a fluid to be measured;
a differential pressure generation mechanism that is installed within the pipe and that is configured to generate a differential pressure between the fluid on an upstream side and the fluid on a downstream side;
a differential pressure sensor configured to measure a differential pressure between a first absolute pressure of the fluid upstream of the differential pressure generation mechanism and a second absolute pressure of the fluid downstream of the differential pressure generation mechanism;
an absolute pressure sensor configured to measure the second absolute pressure;
a temperature sensor configured to measure an ambient temperature of the differential pressure sensor and the absolute pressure sensor;
a pressure calculation section configured to correct an output signal from the differential pressure sensor on the basis of the temperature measured by the temperature sensor to be converted into the differential pressure, and configured to correct an output signal from the absolute pressure sensor on the basis of the temperature measured by the temperature sensor to be converted into the second absolute pressure; and
a flow rate calculation section configured to calculate a flow rate of the fluid on the basis of the differential pressure and the second absolute pressure calculated by the pressure calculation section;
wherein a sensor chip of the differential pressure sensor, a sensor chip of the absolute pressure sensor, and the temperature sensor are accommodated in one package.

8. The differential pressure type flowmeter according to claim 7, wherein
a diaphragm of the differential pressure sensor for receiving the first absolute pressure and the second absolute pressure,
a first pressure guidance path that transmits the first absolute pressure to a first surface of the diaphragm of the differential pressure sensor,
a second pressure guidance path that transmits the second absolute pressure to a second surface opposite to the first surface of the diaphragm of the differential pressure sensor
are provided within the sensor chip of the differential pressure sensor, and
a diaphragm of the absolute pressure sensor for receiving the second absolute pressure, and
a third pressure guidance path that transmits the second absolute pressure to the diaphragm of the absolute pressure sensor
are provided within the sensor chip of the absolute pressure sensor.
